(19) United States
(12) Patent Application Publication
(10) Pub. No.: US 2008/0236343 A1
(43) Pub. Date: Oct. 2, 2008

(54) Bi-directional screwdriver with ratchet driving head

(76) Inventor: Chih-Ching Hsieh Chen, Taichung Hsien (TW)

Correspondence Address: Chih-Ching Hsieh Chen, 235 Chung - Ho, Box 8-24, Taipei, TW

(21) Appl. No.: 11/728,271

(22) Filed: Mar. 26, 2007

(51) Int. Cl. B25B 15/04

(52) U.S. Cl. 81/58.4

(57) ABSTRACT

A bi-directional screwdriver with a ratchet driving head comprises: a dynamic driving unit having a handle at one end thereof and a driving portion at an upper end thereof; a driving switch being protruded out from a lateral side of the handle; a hollow resisting portion being installed at a front end of the driving portion; an inner periphery of the resisting portion having axial teeth; an annular sheet enclosing an outer periphery of the resisting portion; a via hole being formed on the annular sheet; and a connecting unit having one end being installed with a rectangular engaging portion for receiving a sleeve; the connecting unit being detachably connected to the engaging portion; another end of the connecting unit being formed with a ratchet portion; the connecting unit being formed with an axial hole; and a plurality of threads being formed on a rear inner periphery of the connecting unit.

### FIELD OF THE INVENTION

The present invention relates to screwdrivers, and particularly to a bi-directional screwdriver with a ratchet driving head, wherein a dynamic driving unit is connected to the resisting portion with the driving portion. A bi-directionally switch is installed in the resisting portion. If the dynamic power can not be actuated, it can be operated manually. Thus, if the tool is rotated to an extreme position, it is unnecessary to take out for retuning to the original position for locking the screw unit continuously without needing to take out the tool for further actions. Thus the operation is simple and rapid.

### BACKGROUND OF THE INVENTION

The prior art dynamic spanner has a main body, a cylinder, an adjuster, a bearing, an air controlled cover, and an adjusting button. The cover is installed at a rear side of the receiving chamber of the main body for positioning the cylinder, adjuster and bearing. The cover is formed with an air inlet and two air guides. By the action of the button with an air controlled path, the air flowing into and out of the cylinder is controlled so as to control the rotation of the main body and the twisting force of the tool.

The portion dynamic spanner has less elements for driving an object. When the driving device of spanner has fault so that it can not be used, the driving head of the spanner is in a free state and thus it can not be used to drive a screw. In the operation of the prior art spanner, the screw is driven to one half or one third of one cycle, and then the driving head is retracted out and then returned to the original position for further operation. More time and power are needed. However, this is very convenient in the operation. Moreover, it is possible to induce the delay or failure of the work.

### SUMMARY OF THE INVENTION

Accordingly, the primary object of the present invention is to provide a bi-directional screwdriver with a ratchet driving head, wherein a dynamic driving unit is connected to the resisting portion with the driving portion. A bi-directionally switch is installed in the resisting portion. If the dynamic power cannot be actuated, it can be operated manually. Thus, if the tool is rotated to an extreme position, it is unnecessary to take out for retuning to the original position for locking the screw unit continuously without needing to take out the tool for further actions. Thus the operation is simple and rapid.

To achieve above objects, the present invention provides a bi-directional screwdriver with a ratchet driving head, comprising: a dynamic driving unit having a handle at one end thereof and a driving portion at an upper end of the handle; a driving switch being protruded from a lateral side of the handle; a hollow resisting portion is installed at a front end of the driving portion; an upper side of the resisting portion having a through hole; an inner periphery of the resisting portion having axial teeth; an annular sheet enclosing an outer periphery of the resisting portion; a via hole being formed on the annular sheet; and a connecting unit having one end being installed with a rectangular engaging portion for receiving a sleeve; the connecting unit is detachably connected to the engaging portion; another end of the connecting unit being formed with a ratchet portion; an inner side of the ratchet portion being installed with a plurality of ratchets; an axial center of the connecting unit being formed with an axial hole ; a plurality of threads are formed a rear inner periphery of the connecting unit.

The various objects and advantages of the present invention will be more readily understood from the following detailed description when read in conjunction with the appended drawing.

### BRIEF DESCRIPTION OF THE DRAWINGS

FIG. 1 is a bi-directional screwdriver with a ratchet driving head of the present invention.

FIG. 2 is a schematic view about the bi-directional screwdriver with a ratchet driving head of the present invention.

FIG. 3 is a cross sectional view about the bi-directional screwdriver with a ratchet driving head of the present invention.

FIGS. 4 and 5 are schematic views showing the switching along line AB of FIG. 2.

FIGS. 6 and 7 are schematic views showing the locking and detaching operation by using the bi-directional screwdriver with a ratchet driving head of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

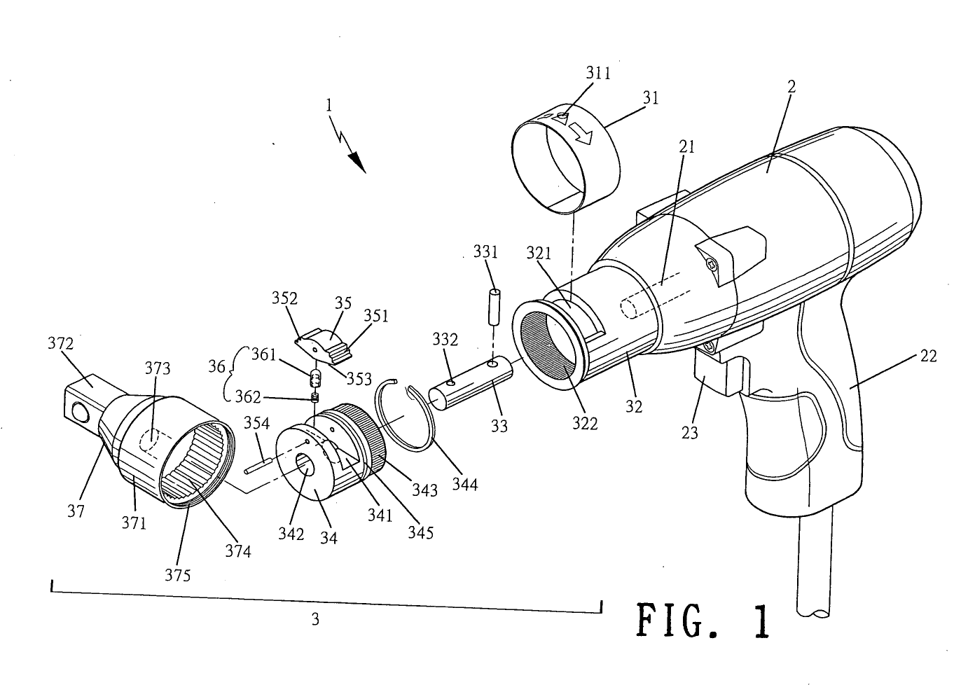

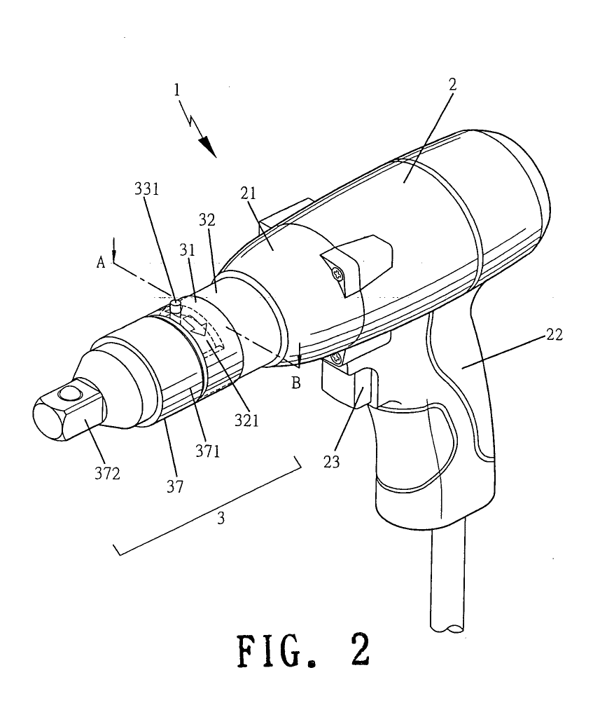

Referring to FIG. 1, the structure 1 of the present invention is illustrated. The present invention has the following elements.

A dynamic driving unit 2 has a handle 22 at one end thereof and a driving portion 21 at an upper end of the handle 22. A driving switch 23 is protruded from a lateral side of the handle 22. The angle between the handle 22 and the driving portion 21 is a predetermined value.

A hollow resisting portion 32 is installed at a front end of the driving portion 21. The resisting portion 32 is integrally formed with or separated from the driving portion 21. An upper side of the resisting portion 32 has a through hole 321. An inner periphery of the resisting portion 32 has axial teeth 322. An annular sheet 31 encloses an outer periphery of the resisting portion 32. A via hole 311 is formed on the annular sheet 31. The annular sheet 31 can be formed with indications for indicating rotating direction.

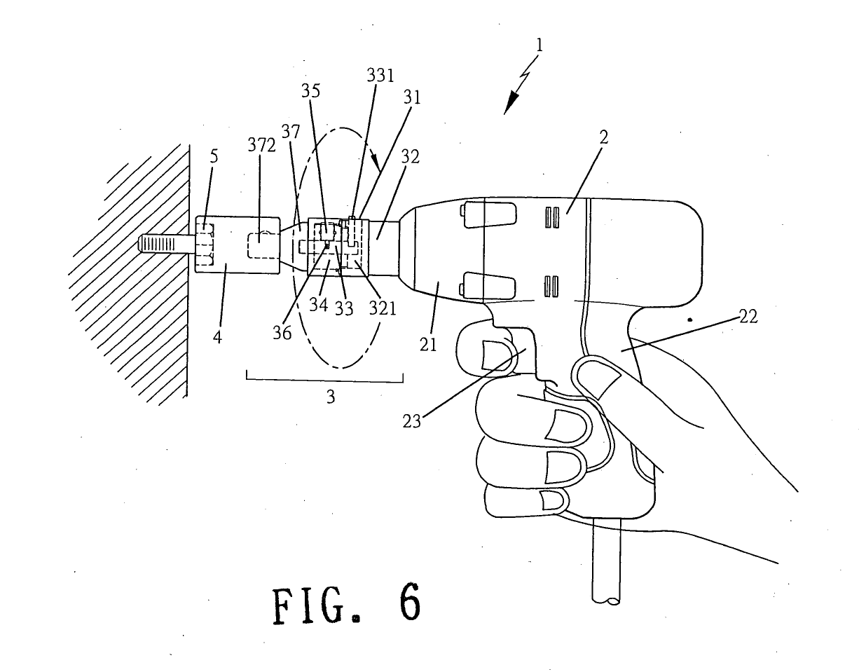

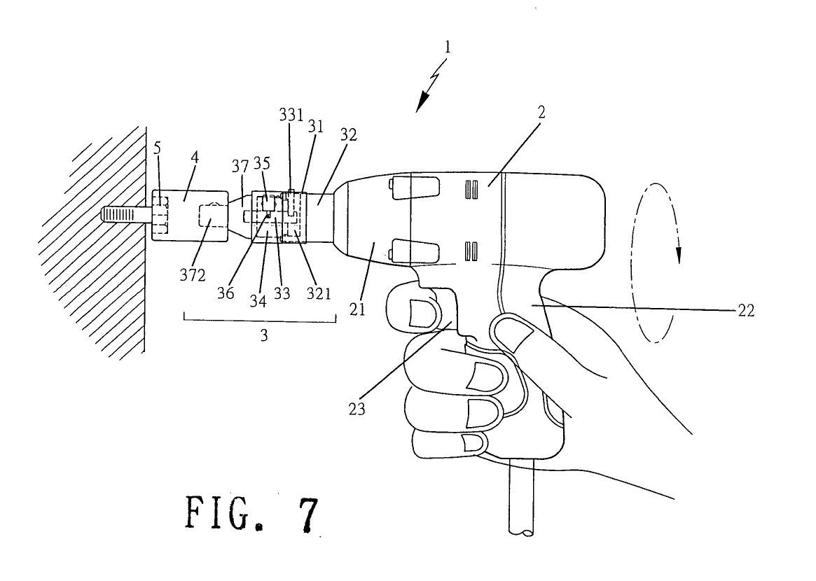

A connecting unit 37 has one end being installed with a rectangular engaging portion 372 for receiving a sleeve 4 (referring to FIGS. 6 and 7). The connecting unit 37 is detachably connected to the engaging portion 372. Another end of the connecting unit 37 is formed with a ratchet portion 371. An inner side of the ratchet portion 371 is installed with a plurality of ratchets 374. An axial center of the connecting unit 37 is formed with an axial hole 373. A plurality of threads 375 are formed in a rear inner periphery of the connecting unit 37.

A rotary portion 33 has a part installed in the axial hole 373 of the connecting unit 37. The rotary portion 33 has a recess 332 at a lateral side thereof. Another end of the rotary portion 33 is installed with a switch 331. The switch 331 is received in the through hole 321 of the resisting portion 32 and the via hole 311 of the annular sheet 31 with a part of the switch 331 protrudes out from the annular sheet 31.

A wheel portion 34 has a penetrating axial hole 342 for receiving the rotary portion 33. A rear end of the wheel portion 34 is formed with teeth 343. An upper lateral side of the wheel portion 34 is formed with a trench 341 which is communicated with the axial hole 342. A buckling block 35 is received within the trench 341. An annular recess 345 is formed on the wheel portion 34 and is between the trench 341 and the teeth 343 for receiving a C ring 344. Thereby by the thread 375 of the connecting unit 37, the connecting unit 37 is rotatably installed to the wheel portion 34. A pivot shaft 354 penetrates through the buckling block 35 and two ends of the pivot shaft 354 is installed in two lateral sides of the trench 341 so that the buckling block 35 is pivoted to the wheel portion 34. Two upper ends of the buckling block 35 are installed with a first teeth 351 and a second teeth 352. A lower side of the buckling block 35 is formed with two inclined surfaces 353 which are connected with an obtuse angle is formed therebetween. A control unit 36 is installed in the buckling block 35 and the trench 341. The control unit 36 is formed by a resisting unit 361 and an elastic unit 362. The elastic unit 362 is installed in a recess 332 of the rotary portion 33. By rotating the switch 331, the control unit 36 rotates therewith so that the buckling block 35 is pushed to move leftwards and rightwards to buckle with the ratchets 374 of the ratchet portion 371. Thus, the structure of the present invention can rotate bi-directionally.

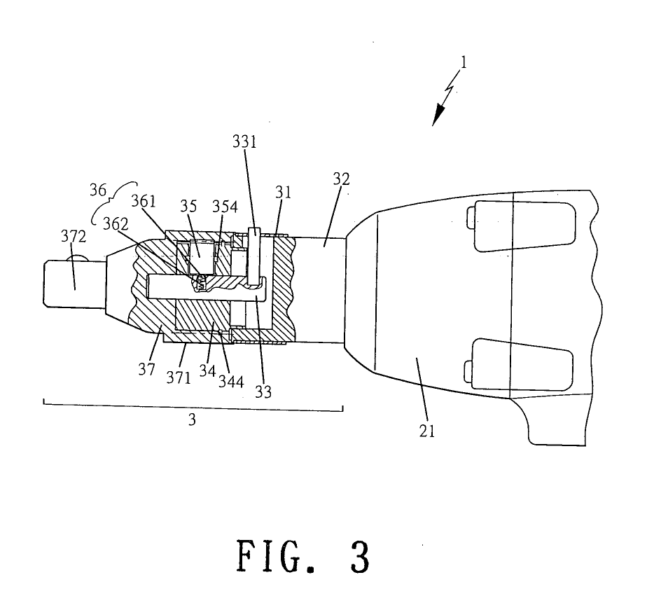

Referring to FIG. 3, in the present invention, the dynamic driving unit 2 uses the driving switch 23 to control the driving portion 21. The driving portion 21 is integrally formed or detachably formed with the resisting portion 32 so that the resisting portion 32 moves with the driving portion 21. The resisting portion 32 is installed with teeth 322 with is engageable with the teeth 343 of the wheel portion 34 so that the resisting portion 32 will drive the wheel portion 34 to move. The wheel portion 34 is installed with the rotary portion 33. The rotary portion 33 is installed with a switch 331 near the resisting portion 32. The switch 331 passes through the through hole 321 of the resisting portion 32 and the via hole 311 of the annular sheet 3 1 with a part protruding out. The rotary portion 33 is formed with a recess 332 near the wheel portion 34 for installing the control unit 36. The control unit 36 resists against the buckling block 35. The connecting unit 37 is pivotally installed with the wheel portion 34 by using the C ring 344. The buckling block 35 is pivoted to the wheel portion 34 by using the pivot shaft 354. The buckling block 35 has the inclined surfaces 353 for resisting against the control unit 36 and resists against the ratchet portion 371 of the connecting unit 37 by using the first teeth 351 and second teeth 352 so that the present invention has the function of bi-directionally rotating.

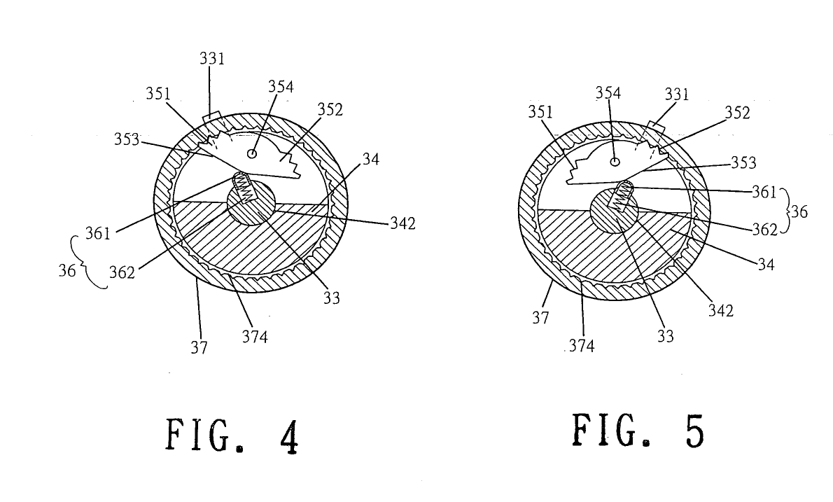

Referring to FIGS. 4 and 5, the operation of the present invention is illustrated. When the switch 331 is driven to resist against the inclined surface 353 at a lower side of the first teeth, if the user drives the structure 1 of the present invention, the control unit 36 slides along the inclined surface 353 so that the first teeth 351 is firmly retained with the ratchet of the connecting unit 37. As a result, it cannot be used to drive a screw unit 5. If the user drives the structure 1 counterclockwise, the control unit 36 resists against the inclined surface 353 so that the first teeth 351 resists against the ratchet 374 of the connecting unit 37. Thus when the connecting unit 37 is driven, it can be used to drive a substrate. On the contrary, when the switch 331 is driven to shift toward the second teeth 352 and resists against the inclined surface 353 at the bottom of the second teeth 352, if the user drives the structure counterclockwise, the control unit 36 slides along the inclined surface 353 so that the second teeth 352 can not firmly secure to the ratchet 374 of the connecting unit 37. As a result, it cannot be used to drive a screw unit 5. If the user drives the structure clockwise, the control unit 36 will resist against the inclined surface 353 so that the second teeth 352 resists against the ratchet 374 of the connecting unit 37. Thus, the connecting unit 37 is retained for driving the screw unit 5.

Referring to FIGS. 6 and 7, in use of the present invention, the dynamic driving unit 2 is used with a sleeve 4 which is then driven by electric power or gas power or manually so as to lock or detach a screw unit 5. Referring to FIG. 6, in locking a screw unit 5, the driving switch 23 is pressed, the driving portion 21 will driven electrically or pneumatically. The buckling block 35 is driven by the driving portion 21. The teeth 322 of the resisting portion 32 will be engaged to the teeth 343 of the wheel portion 34 so as to drive the wheel portion 34. The connecting unit 37 is pivoted to the wheel portion 34 by using the C ring 344. The wheel portion 34 resists against the ratchets 374 by using the first teeth 351 and second teeth 352 of the buckling block 35. Thus, the connecting unit 37 is driven. It is only necessary to press the driving switch 23, the connecting unit 37 will drive to rotate for locking or detaching a screw unit 5. If the dynamic driving unit 2 is not driven by externally forces, as illustrated in FIG. 7, the user holds the handle 22 as a rotating axle. Then the connecting unit 37 is rotated. Then the switch 331 is driven to adjust the rotation way. When the screw unit 5 is rotated to an extreme position of the wrist of the user's hand, the connecting unit 37 is hindered so that the control unit 36 slides along the inclined surface 353. The first teeth 351 or the second teeth 352 is separated from the ratchet 374 so that the dynamic driving unit 2 returns to the original position for continuing the locking and detaching operations.

In the present invention, a dynamic driving unit is connected to the resisting portion 32 with the driving portion 21. A bi-directionally switch is installed in the resisting portion 32. If the dynamic power can not be actuated, it can be operated manually. Thus, if the tool is rotate to an extreme position, it is unnecessary to take out for retuning to the original position for locking the screw unit 5 continuously without needing to take out the tool for further actions. Thus the operation is simple and rapid.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bi-directional screwdriver with a ratchet driving head, comprising:
a dynamic driving unit having a handle at one end thereof and a driving portion at an upper end of the handle; a driving switch being protruded out from a lateral side of the handle;
a hollow resisting portion installed at a front end of the driving portion; an upper side of the resisting portion having a through hole; an inner periphery of the resisting portion having axial teeth; an annular sheet enclosing an outer periphery of the resisting portion; and a via hole being formed on the annular sheet; and
a connecting unit having one end being installed with a rectangular engaging portion for receiving a sleeve; the connecting unit being detachably connected to the engaging portion; another end of the connecting unit being formed with a ratchet portion; an inner side of the ratchet portion being installed with a plurality of ratchets; an axial center of the connecting unit being formed with an axial hole ; and a plurality of threads are formed a rear inner periphery of the connecting unit.

2. The bi-directional screwdriver with a ratchet driving head as claimed in claim 1, further comprising:
a rotary portion having a part installed in the axial hole of the connecting unit; the rotary portion having a recess at a lateral side thereof; another end of the rotary portion being installed with a switch; the switch being received in the through hole of the resisting portion and the via hole of the annular sheet with a part of the switch protruding out from the annular sheet.

3. The bi-directional screwdriver with a ratchet driving head as claimed in claim 2, further comprising:
a wheel portion having a penetrating axial hole for receiving the rotary portion; and a rear end of the wheel portion being formed with teeth.

4. The bi-directional screwdriver with a ratchet driving head as claimed in claim 3, wherein an upper lateral side of the wheel portion is formed with a trench which is communicated with the axial hole; and a buckling block is received within the trench.

5. The bi-directional screwdriver with a ratchet driving head as claimed in claim 4, wherein an annular recess is formed on the wheel portion and is between the trench and the teeth for receiving a C ring; thereby by the thread of the connecting unit, the connecting unit is rotatably installed to the wheel portion.

6. The bi-directional screwdriver with a ratchet driving head as claimed in claim 5, wherein
a pivot shaft penetrating through the buckling block and two ends of the pivot shaft being installed in two lateral sides of the trench so that the buckling block is pivoted to the wheel portion.

7. The bi-directional screwdriver with a ratchet driving head as claimed in claim 6, wherein
two upper ends of the buckling block being installed with a first teeth and a second teeth; a lower side of the buckling block is formed with two inclined surfaces which are connected with an obtuse angle is formed therebetween.

8. The bi-directional screwdriver with a ratchet driving head as claimed in claim 7, wherein
a control unit is installed in the buckling block and the trench; the control unit is formed by a resisting unit and an elastic unit; the elastic unit is installed in a recess of the rotary portion; by rotating the switch, the control unit rotates therewith so that the buckling block is pushed to move leftwards and rightwards to buckle with the ratchets of the ratchet portion.

9. The bi-directional screwdriver with a ratchet driving head as claimed in claim 1, wherein the resisting portion is integrally formed with or separated from the driving portion.

10. The bi-directional screwdriver with a ratchet driving head as claimed in claim 1, wherein the annular sheet is formed with indications for indicating rotating direction.
